(19) United States
(12) Patent Application Publication
(10) Pub. No.: US 2015/0142638 A1
(43) Pub. Date: May 21, 2015

(54) CALCULATING A PROBABILITY OF A BUSINESS BEING DELINQUENT

(71) Applicant: The Dun & Bradstreet Corporation, Short Hills, NJ (US)

(72) Inventors: Alla KRAMSKAIA, Edison, NJ (US); Paul Douglas BALLEW, Madison, NJ (US); Nipa BASU, Bridgewater, NJ (US); Michael Eric DANITZ, Chatham, NJ (US); Brian Scott CRIGLER, Westfield, NJ (US); Karolina Anna KIERZKOWSKI, Linden, NJ (US); John Mark NICODEMO, Bethlehem, PA (US); Xin YUAN, Basking Ridge, NJ (US); Don L. Folk, Quakertown, PA (US)

(73) Assignee: THE DUN & BRADSTREET CORPORATION, Short Hills, NJ (US)

(21) Appl. No.: 14/267,505

(22) Filed: May 1, 2014

Related U.S. Application Data
(60) Provisional application No. 61/818,784, filed on May 2, 2013.

(51) Int. Cl. G06Q 40/02

(52) U.S. Cl. CPC G06Q 40/025
USPC 705/38

(57) ABSTRACT

There is provided a method that includes employing a computer to perform operations of (a) receiving, from a data source, by way of an electronic communication, a descriptor of a business, (b) matching said descriptor to data in a database, thus yielding a match, wherein said data includes a unique identifier of said business, (c) saving to a log, a signal that includes said unique identifier, (d) counting a quantity of signals that include said unique identifier in said log, thus yielding a number of said signals for said unique identifier, and (e) calculating a credit score for said business, based on said number of signals. There is also provided a system that performs the method, and a storage device that controls a processor to perform the method.

### CROSS-REFERENCE TO RELATED APPLICATIONS

The present application is claiming priority to U.S. Provisional Patent Application No. 61/818,784, filed on May 2, 2013, the content of which is herein incorporated by reference.

### BACKGROUND OF THE DISCLOSURE

1. Field of the Disclosure

The present disclosure pertains to the field of predictive scoring, and more particularly credit scoring.

2. Description of the Related Art

The approaches described in this section are approaches that could be pursued, but not necessarily approaches that have been previously conceived or pursued. Therefore, the approaches described in this section may not be prior art to the claims in this application and are not admitted to be prior art by inclusion in this section.

A credit score assigns a probability of late payment to a business, i.e., a probability of being delinquent. There are two kinds of credit scores, namely judgmental and statistical. A judgmental score is created by a credit manager based on the credit manager's judgment and experience. A statistical score is a result of a statistical analysis of a business's credit files, to represent the creditworthiness of that business.

In statistics, regression analysis is a statistical process for estimating relationships among variables. It includes techniques for modeling and analyzing several variables, when the focus is on a relationship between a dependent variable and one or more independent variables. Regression analysis helps one understand how a typical value of the dependent variable changes when any one of the independent variables is varied, while the other independent variables are held fixed.

The accuracy of the regression analysis depends, in part, on the form of the model that is used, and on the selection of the independent variables. That is, a well-formed model and a proper selection of independent variables can lead to a more accurate result.

Data to be analyzed for credit scoring is typically stored in database. Due to the increased amounts of data being generated, stored, and processed today, operational databases are constructed, categorized, and formatted for operational efficiency (e.g., throughput, processing speed, and storage capacity). The raw data found in these operational databases often exist as rows and columns of numbers and code that appear bewildering and incomprehensible to business analysts and decision makers. Furthermore, the scope and vastness of the raw data stored in modern databases render it harder locate usable information.

Thus, there is a need for a technique that analyzes data from one or more databases, to develop a model, and identify and select independent variables, for a regression analysis.

### SUMMARY OF THE DISCLOSURE

It is an object of the present disclosure to provide for a technique that analyzes data from one or more databases, to develop a model, and identify and select independent variables, for a regression analysis.

It is a further objective of the present disclosure to provide for a technique that utilizes the model to evaluate data concerning a subject business, to generate a credit score for the subject business.

To fulfill these objectives, there is provided a method that includes employing a computer to perform operations of (a) receiving, from a data source, by way of an electronic communication, a descriptor of a business, (b) matching said descriptor to data in a database, thus yielding a match, wherein said data includes a unique identifier of said business, (c) saving to a log, a signal that includes said unique identifier, (d) counting a quantity of signals that include said unique identifier in said log, thus yielding a number of said signals for said unique identifier, and (e) calculating a credit score for said business, based on said number of signals. There is also provided a system that performs the method, and a storage device that controls a processor to perform the method.

### BRIEF DESCRIPTION OF THE DRAWINGS

FIG. 1 is a block diagram of a system for employment of the techniques disclosed herein.

FIG. 2 is a block diagram of a processing module of the system of FIG. 1.

FIG. 3 is a block diagram of an activity signal generator that is a component of the processing module of FIG. 2.

FIG. 4 is a block diagram of an account receivable processing module that is a component of the processing module of FIG. 2.

FIG. 4A is an illustration of a table that lists exemplary interim calculations performed by the account receivable processing module of FIG. 4.

FIG. 5 is a block diagram of a model generator that is a component of the processing module of FIG. 2.

FIG. 5A is an illustration of a table that shows a first exemplary model development data set produced by the model generator of FIG. 5.

FIG. 5B is an illustration of a table that shows a second exemplary model development data set produced by the model generator of FIG. 5.

FIG. 6 is a block diagram of scoring process that is a component of the processing module of FIG. 2.

FIG. 7 is a table that shows an example of a scorecard for a single business being scored in accordance with the scoring process of FIG. 6.

A component or a feature that is common to more than one drawing is indicated with the same reference number in each of the drawings.

### DESCRIPTION OF THE DISCLOSURE

The present disclosure provides for a system and method for calculating a probability of a subject business being delinquent on a payment. The system and method utilizes statistical scores, where an assignment of probability is empirically derived and can be empirically validated. The probability is calculated based on data, referred to herein as activity signals, pertaining to non-payment activities of the subject business. The activity signals are derived from record maintenance processes conducted by other businesses. The probability of the subject business being delinquent is derived from a mathematical technique of finding a relationship between late payments and data concerning the subject business. A model that is developed and utilized by the system provides a definition of bad performance for severely delinquent businesses. A scoring process utilizes the model to generate a score for the subject business.

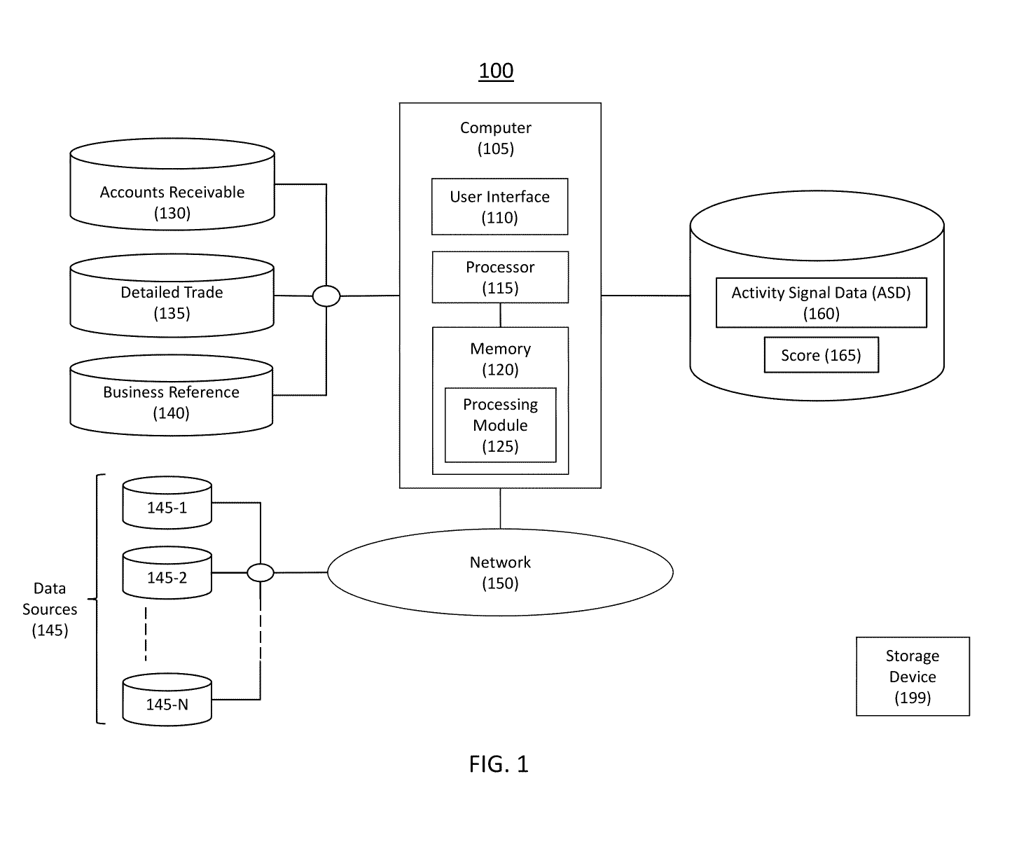

FIG. 1 is a block diagram of a system 100, for employment of the techniques disclosed herein. System 100 includes (a) a computer 105, (b) data sources 145-1, and 145-2 through 145-N, collectively referred to as data sources 145, which are communicatively coupled to computer 105 via a network 150.

Network 150 is a data communications network. Network 150 may be a private network or a public network, and may include any are all of (a) a personal area network, e.g., covering a room, (b) a local area network, e.g., covering a building, (c) a campus area network, e.g., covering a campus, (d) a metropolitan area network, e.g., covering a city, (e) a wide area network, e.g., covering an area that links across metropolitan, regional, or national boundaries, or (f) the Internet. Communications are conducted via network 150 by way of electronic signals and optical signals.

Each of data sources 145 is an entity, organization, or process that provides information, i.e., data, about a business. Examples of data sources 145 include business registries, phone books, staffing data, accounts receivables invoice-level payment data, and business inquiries about other businesses.

Computer 105 processes data from data sources 145, and also processes data that is designated herein as accounts receivable data 130, detailed trade data 135 and business reference data 140, and produces data designated as activity signal data (ASD) 160 and a score 165.

Accounts receivable data 130 is accounts receivable data that has been obtained from a plurality of businesses that have supplied goods or services to other businesses, or credit. Accounts receivable data 130 about a company of interest is obtained from suppliers of goods or services to the company of interest. For example, assume that Company B is a supplier of goods or services to Company A. Company B, on its books, would show an accounts receivable amount due from Company A. In practice, there would likely be many companies that supply goods or services to Company A, and as such, accounts receivable data for Company A would include the accounts receivable data about Company A from those many companies.

Detailed trade data 135 is other data about a company of interest, and may be derived from accounts receivable data 130. Examples of detailed trade data 135 include number of accounts past due in last six months, and total amount owing.

Business reference data 140 is data that describes a business. For example, for a subject business, business reference data 140 will include a unique identifier of the subject business, business information, financial statements, and traditional trade data. The unique identifier is an identifier that uniquely identifies the subject business. A data universal numbering system (DUNS) number can serve as such a unique identifier. Business information is information about a business such as, number of employees, years in business, and an industry, e.g., retail, within which the business is categorized. Financial statements are financial information such as quick ratios, i.e., (current assets-inventory)/current liabilities, and total amount of liabilities. Traditional trade data is information such as amount thirty days or more past due, number of payment experiences thirty days or more past due, and number of satisfactory payment experiences.

ASD 160 is a data structure that contains information about companies, where the information is derived from data obtained from data sources 145. In general, with regard to a subject company, ASD 160 indicates a level of processing activity by other companies, concerning the subject company.

Score 165 is a credit score that represents the creditworthiness of a business to which the credit score is assigned.

Accounts receivable data 130, detailed trade data 135, business reference data 140, ASD 160 and score 165 are stored in one or more databases. The one or more databases can be configured as a single storage device, or as a distributed storage system having a plurality of independent storage devices. Although in system 100 the one or more databases are shown as being directly coupled to computer 105, they can be located remotely from, and coupled to, computer 105 by way of network 150.

Computer 105 includes a user interface 110, a processor 115, and a memory 120 coupled to processor 115. Although computer 105 is represented herein as a standalone device, it is not limited to such, but instead can be coupled to other devices (not shown) in a distributed processing system. User interface 110 includes an input device, such as a keyboard or speech recognition subsystem, for enabling a user to communicate information and command selections to processor 115.

User interface 110 also includes an output device such as a display or a printer, or a speech synthesizer. A cursor control such as a mouse, track-ball, or joy stick, allows the user to manipulate a cursor on the display for communicating additional information and command selections to processor 115.

Processor 115 is an electronic device configured of logic circuitry that responds to and executes instructions.

Memory 120 is a tangible computer-readable storage device encoded with a computer program. In this regard, memory 120 stores data and instructions, i.e., program code, that are readable and executable by processor 115 for controlling operations of processor 115. Memory 120 may be implemented in a random access memory (RAM), a hard drive, a read only memory (ROM), or a combination thereof. One of the components of memory 120 is a processing module 125.

Processing module 125 is a module of instructions that are readable by processor 115, and that control processor 115 to perform a scoring of a business, i.e. evaluation of the business by an assignment of a probability of delinquency which is converted to a delinquency score, i.e., score 165. Processing module 125 outputs results to user interface 110 and can also direct output to a remote device (not shown) via network 150.

In the present document we describe operations being performed by processing module 125 or its subordinate processes. However, the operations are actually being performed by computer 105, and more specifically, processor 115.

The term “module” is used herein to denote a functional operation that may be embodied either as a stand-alone component or as an integrated configuration of a plurality of subordinate components. Thus, processing module 125 may be implemented as a single module or as a plurality of modules that operate in cooperation with one another. Moreover, although processing module 125 is described herein as being installed in memory 120, and therefore being implemented in software, it could be implemented in any of hardware (e.g., electronic circuitry), firmware, software, or a combination thereof.

While processing module 125 is indicated as already loaded into memory 120, it may be configured on a storage device 199 for subsequent loading into memory 120. Storage device 199 is a tangible computer-readable storage medium that stores processing module 125 thereon. Examples of storage device 199 include a compact disk, a magnetic tape, a read only memory, an optical storage media, a hard drive or a memory unit consisting of multiple parallel hard drives, and a universal serial bus (USB) flash drive. Alternatively, storage device 199 can be a random access memory, or other type of electronic storage device, located on a remote storage system and coupled to computer 105 via network 150.

In practice, data sources 145, accounts receivable data 130, detailed trade data 135 and business reference data 140 will contain data representing many, e.g., millions of, data items. Thus, in practice, the data cannot be processed by a human being, but instead, would require a computer such as computer 105.

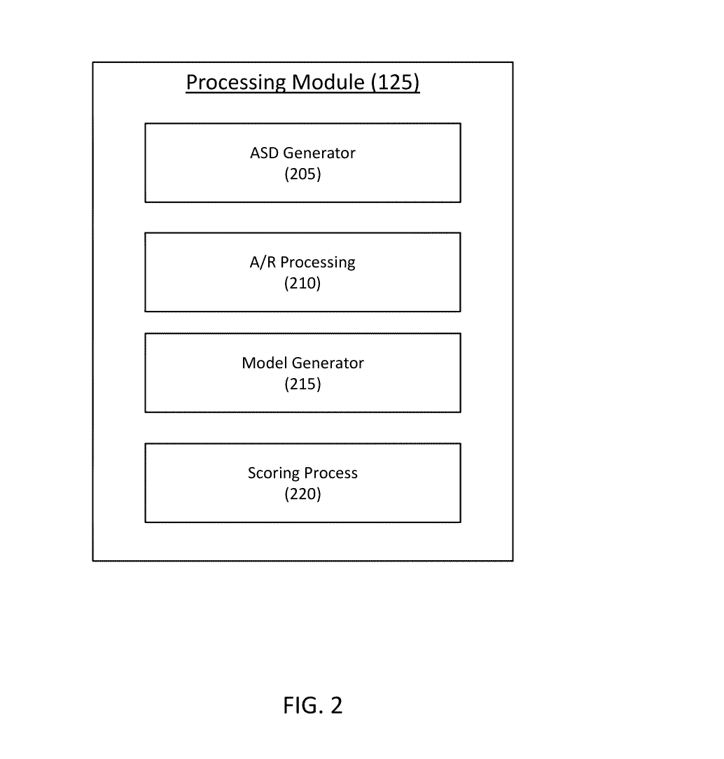

FIG. 2 is a block diagram of processing module 125. Processing module 125 includes several subordinate modules, namely, an activity signal data (ASD) generator 205, accounts receivable (A/R) processing 210, a model generator 215, and a scoring process 220. In brief:
(a) ASD generator 205 analyzes data from data sources 145, and produces ASD 160, which, as mentioned above, with regard to a subject company, indicates a level of processing activity, by other companies, concerning the subject company;
(b) A/R processing 210 analyzes accounts receivable data 130 from suppliers of a subject businesses, and produces weights that are indicative of whether the subject businesses are in good standing with regard to their payments of debts, or delinquent on their payments of debits;
(c) model generator 215 processes various business data, ASD 160 and the weights from A/R processing 210, and based thereon, generates a model for scoring a business; and
(d) scoring process 220 utilizes the model from model generator 215 to produce score 165.
   Each of ASD generator 205, A/R processing 210, model generator 215, and scoring process 220 is described in further detail below.

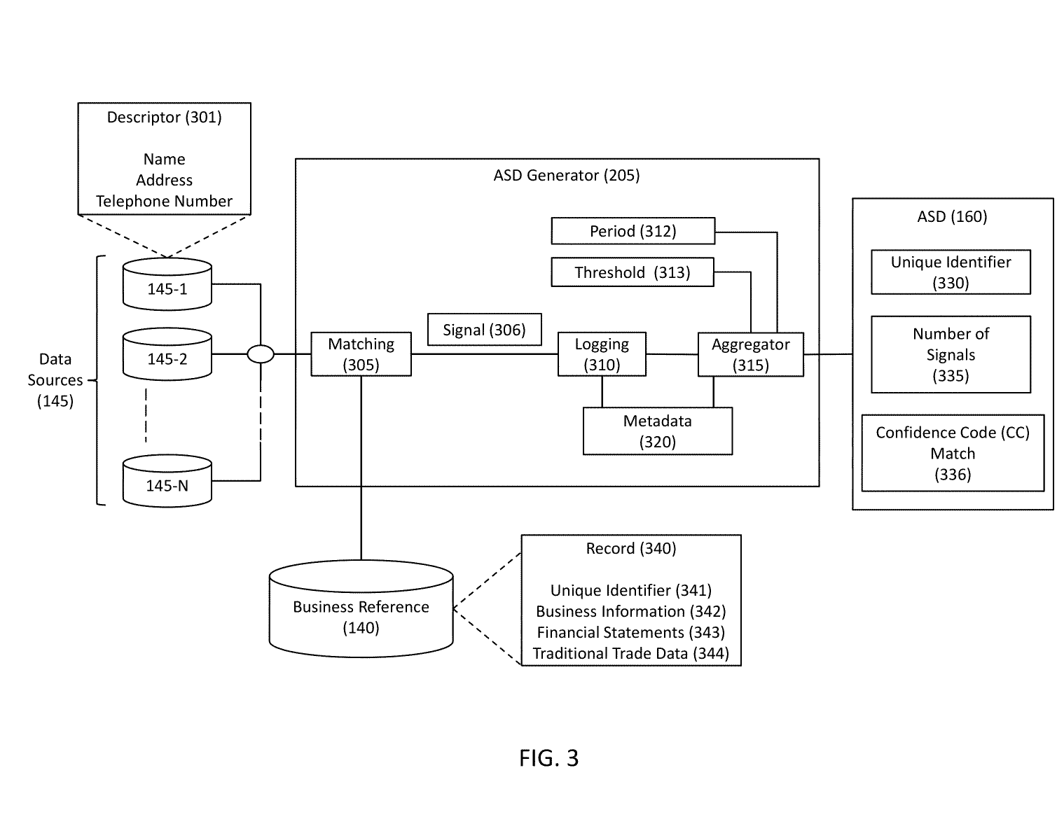

FIG. 3 is a block diagram of ASD generator 205, which, as mentioned above, analyzes data from data sources 145, and produces ASD 160. ASD generator 205 includes a matching process 305, a logging process 310, and an aggregator 315.

Data sources 145, as mentioned above, are entities, organizations, or processes that provide information, i.e., data, about a business. The format of the data is not particularly relevant to the operation of system 100, but for purposes of example, we will assume that the data is organized into records. A descriptor 301 is an example of such a record, and contains data that describes various aspects of a business, for example, name, address and telephone number. In practice, descriptor 301 can include many such aspects.

Matching process 305 receives, or otherwise obtains, from data sources 145, descriptor 301, and matches descriptor 301 to data in business reference data 140.

Attributes of descriptor 301 are populated in a non-consistent manner for each business in data sources 145. Computer 105 uses available descriptor 301 information and based on that information and makes its best possible match. As an example, let's consider that maximum necessary information to achieve a most accurate match is to have information on a business's name and its telephone number. Exemplary data source 145-2 and descriptor 301 provided information only on business name. This limits our accuracy for matching, but computer 105 takes information from that descriptor 301 and searches database 140 to find a record for a business with the highest achievable accuracy and match.

Business reference data 140, as mentioned above, is data that describes a business. Business reference data 140 is organized into records. One such record, i.e., a record 340, is a representative example. Record 340 includes a unique identifier 341, business information 342, financial statements 343, and traditional trade data 344.

Matching, as used herein, means searching a data storage device for data, e.g., searching a database for a record, that best matches a given inquiry. Thus, matching process 305 searches business reference data 140 for data that best matches descriptor 301.

A best match is not necessarily a correct match, and so, matching process 305, upon finding a match, also provides a confidence code that indicates a level of confidence of the match being correct. For example, a confidence code of 5 may indicated that the match is almost definitely correct, and a confidence code of 1 may indicate that the match has a relatively low certainty of being correct.

Matching process 305, upon finding a match, produces a signal 306, which includes:

(a) identification of source from which data was received;
(b) a time (which includes a date) at which the match was made; and
(c) unique identifier 341;
(d) the confidence code.

Logging process 310 receives signal 306, and enters it into a log, designated herein as metadata 320.

In practice, ASD generator 205, or each of its subordinate processes, i.e., matching process 305, logging process 310 and aggregator 315, will operate in a processing loop so as to process a plurality of descriptors from data sources 145. Thus, matching process 205 will produce a plurality of signals, where signal 306 is merely one such signal.

Table 1 lists some exemplary metadata 320.

TABLE 1
Exemplary Metadata 320

| | | | Unique | Confidence |
|---|---|---|---|---|
| Signal | Source | Time | Identifier | Code |
| 1 | 145-2 | t0 | 00000001 | 2 |
| 2 | 145-1 | t1 | 00000002 | 1 |
| 3 | 145-1 | t2 | 00000001 | 3 |
| 4 | 145-1 | t3 | 00000001 | 3 |
| . | . | . | . | . |
| . | . | . | . | . |
| . | . | . | . | . |

For example, Table 1, row 1, shows that matching process 305 produced a first signal, i.e., signal 1, that indicates that matching process 305, at time t0, matched a descriptor 301 from data source 145-2 to data in business reference data 140. The match indicates that descriptor 301 concerns a business identified by unique identifier 00000001, and the match has a confidence code of 2. In practice, metadata 320 will contain many, e.g., millions, of rows of data.

Aggregator 315 aggregates data from metadata 320 to produce ASD 160. More specifically, aggregator 315 considers metadata 320 that falls within a period of time, i.e., a period 312, and, for each unique identifier maintains a total number of signals, and a total number of matches having a confidence code greater than or equal to a threshold 313. Thus, for a subject business, ASD 160 includes, a unique identifier 330, a number of signals 335, and a confidence code (CC) match 336. Number of signals 335 is the total number of signals for a particular unique identifier that were matched during period 312. CC match 336 is the total number of those matches having a confidence code greater than or equal to threshold 313.

For example, referring to Table 1, assume that period 312 defines a period of time from t0 through t4, and that threshold 313 defines a threshold value of 3. Table 2 lists corresponding exemplary data for ASD 160.

TABLE 2
Exemplary Data for ASD 160

| | | Matches having confidence |
|---|---|---|
| Unique | Total number | code greater than or |
| Identifier (unique | of signals (number | equal to threshold |
| identifier 330) | of signals 335) | (CC match 336) |
| 00000001 | 3 | 2 |
| 00000002 | 1 | 0 |

Table 2 shows that, during the period of t0 through t4, for unique identifier 00000001, there was a total of 3 signals (see Table 1, signals 1, 3 and 4), and of those 3 signals, 2 of them were for matches having a confidence code of greater than or equal to 3 (see Table 1, rows 3 and 4). Although not shown in Table 2, ASD 160 can include other information derived from signal 306, for example an identification of data sources 145 that provided data that resulted in the greatest number of matches having a confidence code greater than or equal to threshold 313. In practice, period 312 will be of a length, e.g., 12 months, that enables ASD generator 205 to gather a significant number of events. As such, ASD 160 will include many, e.g., millions, of rows of data.

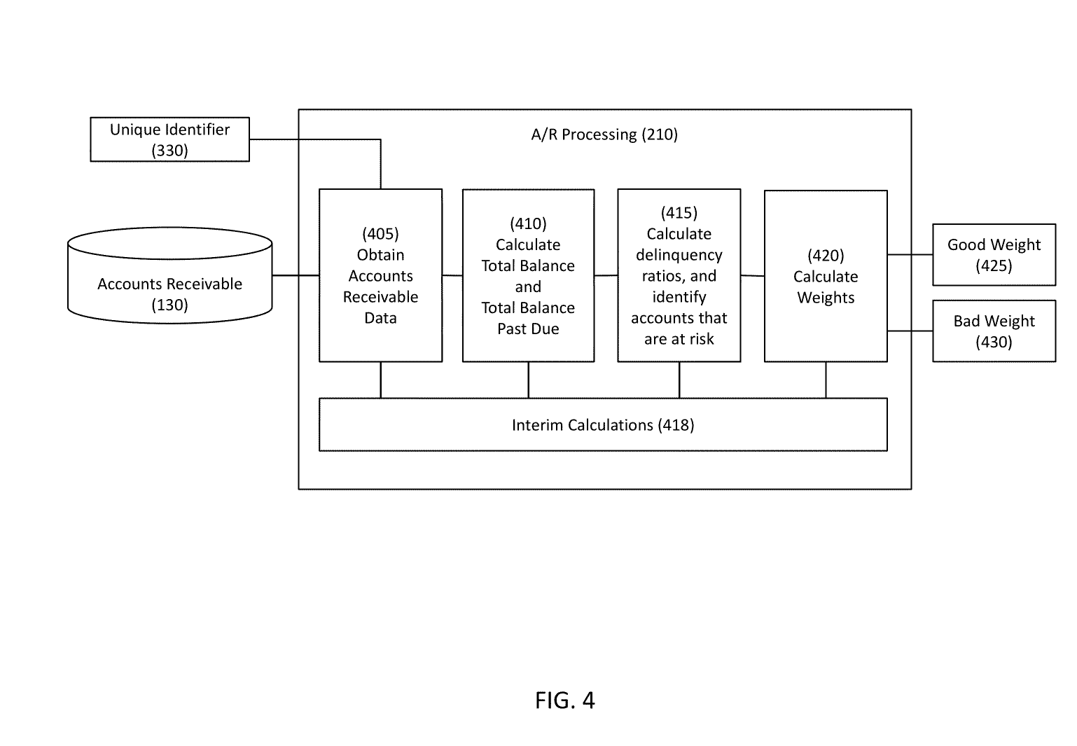

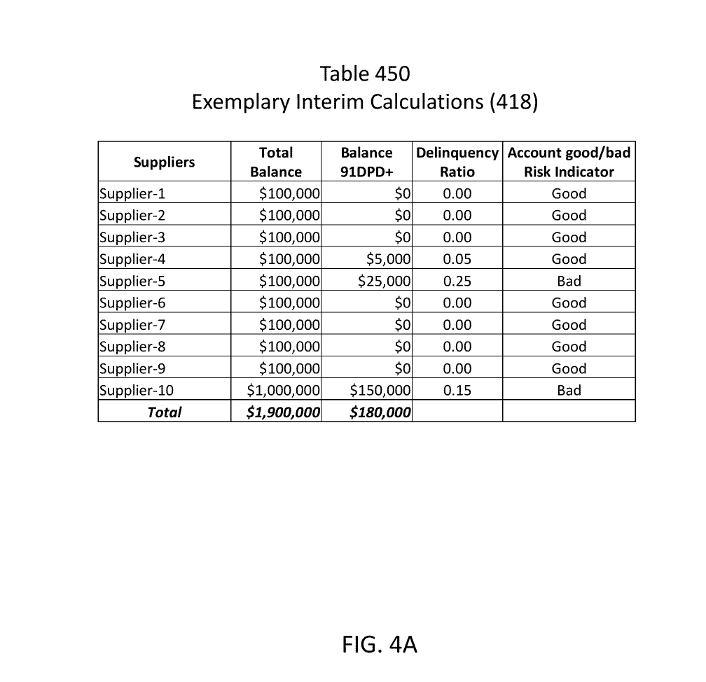

FIG. 4 is a block diagram of A/R processing 210, which, as mentioned above, analyzes accounts receivable data 130 from suppliers of a subject business, and produces weights that are indicative of whether the subject businesses are in good standing with regard to their payments of debts, or delinquent on their payments of debits.

During execution, A/R processing 210 produces interim calculations 418. FIG. 4A is an illustration of a table, i.e., a Table 450, that lists exemplary interim calculations 418.

A/R processing 210 commences with step 405.

In step 405, A/R processing 210 obtains accounts receivable data 130 for a subject business, which is identified by unique identifier 330. More specifically, for each supplier, i.e., creditor, of the subject business, A/R processing 210 obtains a balance that is due to the supplier from the subject business, and an amount of that balance that is past due, for example, 91 or more days past due. This information is stored in interim calculations 418.

Table 450 shows, for example, that the subject business (a) owes Supplier-1 $100,000, of which $0 is 91 or more days past due, and (b) owes Supplier-10 $1,000,000, of which $150,000 is 91 or more days past due.

From step 405, A/R processing 210 progresses to step 410.

In step 410, A/R processing 210 calculates a total balance owed by the subject business, and an amount of that total balance that is 91 or more days past due. This information is stored in interim calculations 418. Table 450 shows, for example, (a) the total balance owed is $1,900,000, and (b) of that total balance, $180,000 is 91 or more days past due.

From step 410, A/R processing 210 progresses to step 415.

In step 415, A/R processing 210 calculates delinquency ratios, and identifies accounts that are at risk.

One technique for assessing credit of the subject business would be to calculate a ratio of (a) total balance past due to (b) total balance owed. If the ratio is greater than a particular value, e.g., 0.10, that indicates that more than some particular percentage, e.g., 10%, is past due, the subject business would be classified as a bad credit risk. Using the data presented in Table 450:

Total Balance Past Due/Total Balance Owed=180,000/1,900,000=0.095 EQU 1

Thus, EQU 1 indicates that less than 10% is past due, and that the subject business would not be classified as a bad credit risk.

However, a subject business can be in good terms with one service provider, but be late on its payments with another. To address this concern, A/R processing 210 considers payment delinquency for each individual supplier, and thus incorporates different degrees of delinquency into a definition of a bad credit risk. More specifically, for each supplier, A/R processing 210 calculates a delinquency ratio of (a) balance past due to (b) balance owed, as shown in EQU 2. If the delinquency ratio is greater than a particular value, e.g., 0.10, the subject business's account with that supplier is identified as a bad credit risk.

Delinquency Ratio=Balance Past Due/Balance Owed EQU 2

### For Supplier-5:

Delinquency Ratio=25,000/100,000=0.25 EQU 3

For Supplier-10:

Delinquency Ratio=150,000/1,000,000=0.15 EQU 4

Thus, with regard to Supplier-5 and Supplier10, the subject business's account is classified as a bad credit risk.

From step 415, A/R processing 210 progresses to step 420.

In step 420, for the subject business, A/R processing 210 calculates a good weight 425 and a bad weight 430.

To calculate good weight 425, A/R processing 210 calculates a total amount owed to suppliers for which accounts are designated as good, i.e., a good total, and then calculates a ratio of (a) the good total to (b) the total balance owed. In the present example, shown in Table 450, the good total is the total owed to Suppliers-1, 2, 3, 4, 6, 7, 8 and 9. Here, the good total=800,000, and:

Good Weight=Good Total/Total Balance Owed=800,000/1,900,000=0.42 EQU 5

To calculate bad weight 430, A/R processing 210 calculates a total amount owed to suppliers for which accounts are designated as bad, i.e., a bad total, and then calculates a ratio of (a) the bad total to (b) the total balance owed. In the present example, shown in Table 450, the bad total is the total owed to Suppliers 5 and 10. Here the bad total=1,100,000, and:

Bad Weight=Bad Total/Total Balance Owed=1,100,000/1,900,000=0.58 EQU 6

Note that a sum of the good weight and the bad weight is equal to 1, i.e., 0.42+0.58=1. These weights can also be scaled, for example, on a scale of 100, and in the present example, the good weight would take on a value of 42, and the bad weight would take on a value of 58.

Looking at the account level business payment behaviors allows for weighting the outstanding balance to total amount the business owes, which captures the true business performance towards multiple suppliers and business tendencies.

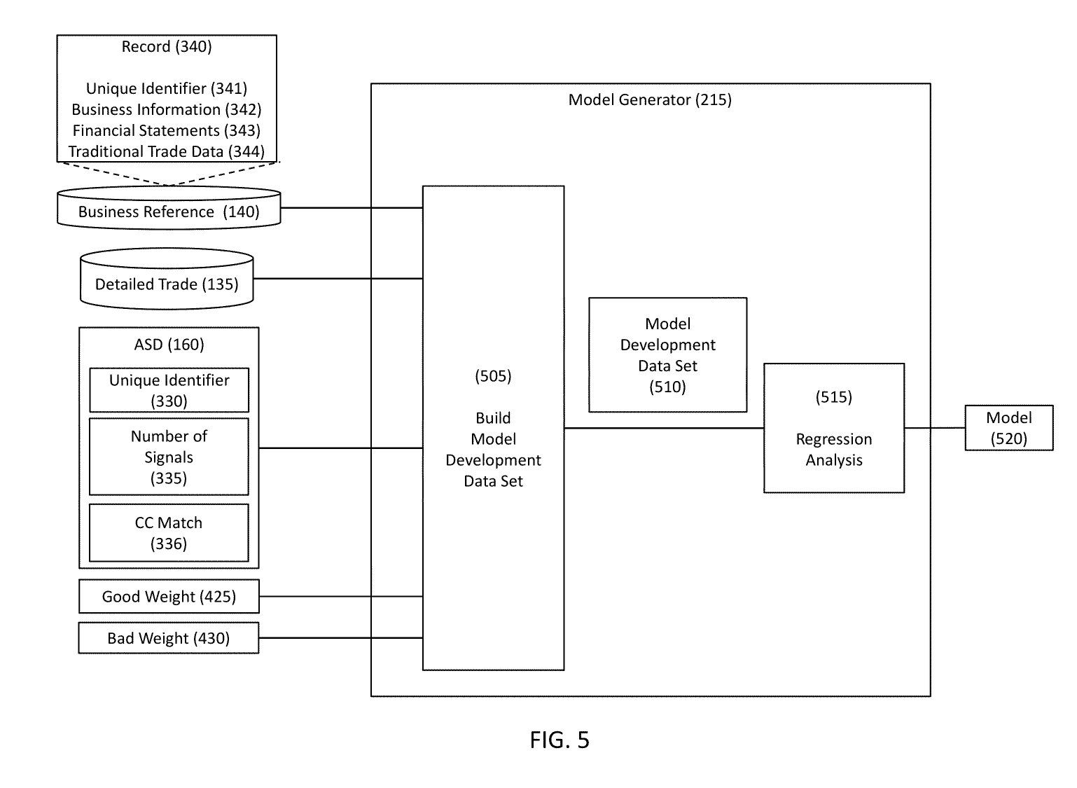

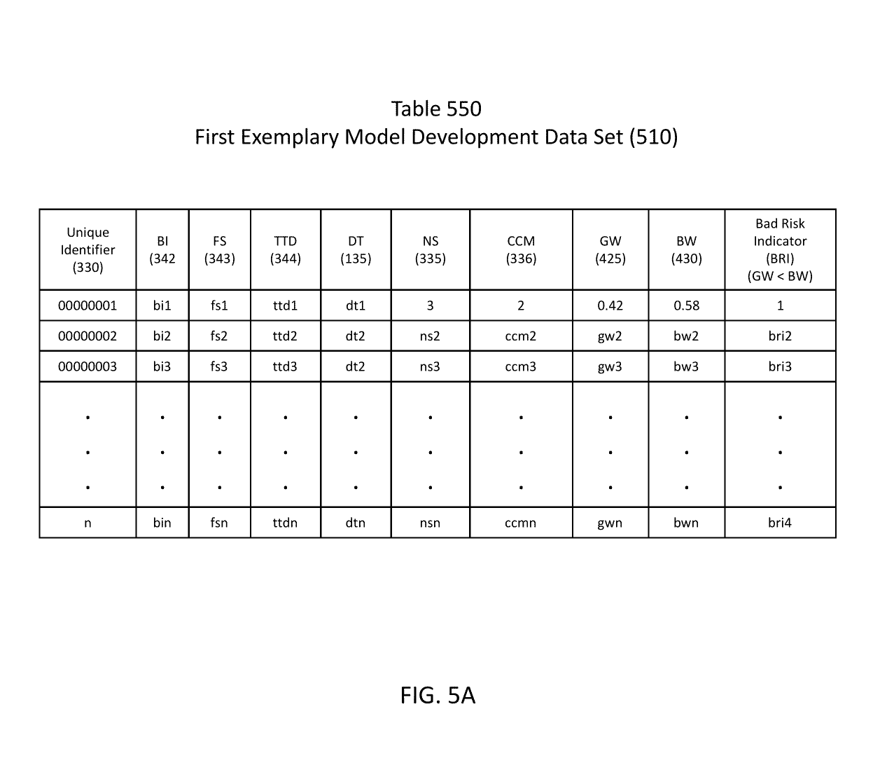

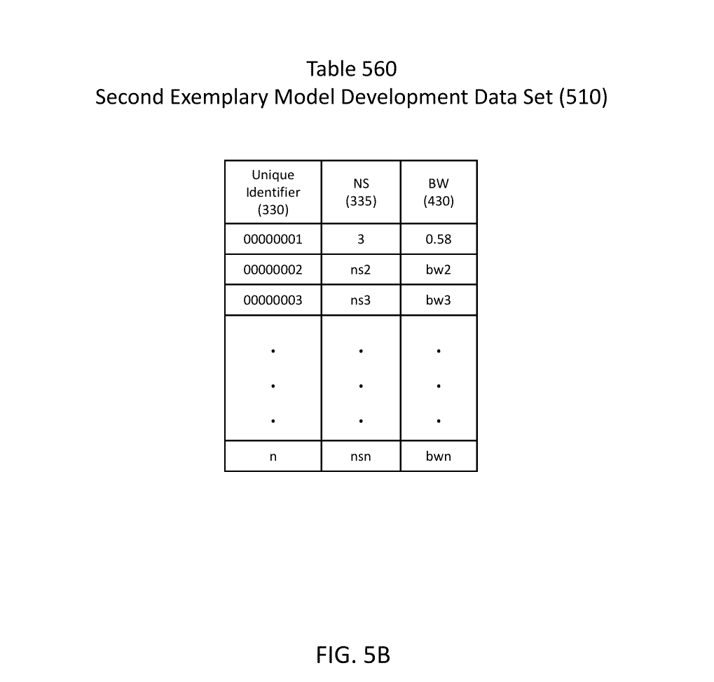

FIG. 5 is a block diagram of model generator 215, which, as mentioned above, processes various business data, ASD 160 and the weights from A/R processing 210, and based thereon, generates a model for scoring a business. Model generator 215 commences with step 505.

In step 505, model generator 215 receives business reference data 140, detailed trade data 135, ASD 160, good weight 425, and bad weight 430, and builds a model development data set 510.

FIG. 5A is an illustration of a table, i.e., a Table 550, that shows a first exemplary model development data set 510.

Table 550 has a header row that lists:

(1) unique identifier;

(2) predictors:
(a) business information (BI) 342;
(b) financial statements (FS) 343;
(c) traditional trade data (TTD) 344;
(d) detailed trade (DT) data 135;
(e) number of signals (NS) 335; and
(f) confidence code match (CCM) 336;
(g) good weight (GW) 425; and
(h) bad weight (BW) 430; and

(3) a bad risk indicator (BRI).

In Table 550, each unique identifier identifies a subject business. For example, the subject business that corresponds to unique identifier 00000001. The predictors are data items that characterize the subject business. There can be any number of unique identifiers and any number of predictors, and in practice, there will be many, e.g., millions, of unique identifiers, and many, e.g., hundreds, of predictors. Additionally, in practice, each of the predictors in Table 550 represents a plurality of predictors. For example, in practice, instead of a single column for business information, there will be columns for number of employees, years in business, and industry. The predictors are regarded as independent variables for regression analysis. Note, for example, that each of number of signals (NS) 335, confidence code match (CCM) 336, good weight (GW) 425, and bad weight (BW) 430 is an independent variable.

Also in Table 550, cells in the column designated as bad risk indicator (BRI) contain a value of “1” when the subject business is regarded as being a bad risk, for example, when the subject business's good weight is less than its bad weight. The cell would contain a value of “0” when the subject business is regarded as not being a bad risk. The designation of good risk or bad risk can be based on any desired combination of predictors. The bad risk indicator is regarded as a dependent variable for the purpose of regression analysis.

The dependent variable in a statistical model is the measurement we are trying to predict using multiple predictors, i.e. independent variables. Model generator 215 thus differentiates between good payment behavior and bad payment behavior on an obligation between a subject business and a supplier to define a dependent variable, in this case, the bad risk indicator.

FIG. 5B is an illustration of a table, i.e., a Table 560, that shows a second exemplary model development data set 510.

Table 560 has a header row that lists:

(1) unique identifier; and

(2) predictors:
(a) number of signals (NS) 335; and
(b) bad weight (BW) 430.

Note, for example, that each of number of signals (NS) 335 and bad weight (BW) 430 is an independent variable. Given Table 560, the bad risk indicator, i.e., the dependent variable, can be derived from bad weight (BW) 430. For example, if bad weight is greater than or equal to 0.50, then bad risk indicator is assumed to be 1.

From step 505, model generator 215 progresses to step 515.

In step 515, model generator 215 performs a regression analysis on model development data set 510, and generates a regression model, i.e., a model 520. EQU 7 is a general form of model 520.

Score=C1(predictor 1)+C2(predictor 2)++Cm(predictor m) EQU 7

Model 520 is thus an equation that consists of a series of variables and coefficients that have been calculated for each variable. For example, in a case where model development data set 510 is as shown in Table 560, the values of number of signals (NS) 335 and bad weight (BW) 430, i.e., the independent variables, would serve as predictors in EQU 7.

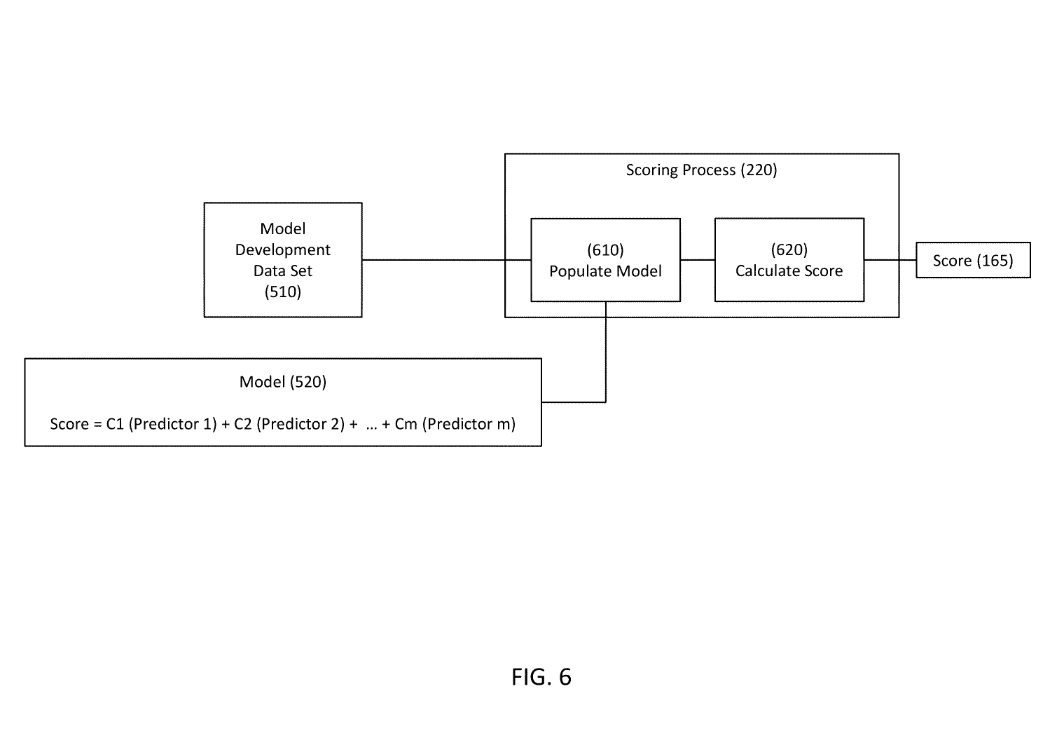

FIG. 6 is a block diagram of scoring process 220, which, as mentioned above, utilizes the model from model generator 215 to produce score 165. Scoring process 220 commences with step 610.

In step 610, scoring process 220 obtains data from model development data set 510, and populates model 520. From step 610, scoring process 220 progresses to step 620.

In step 620, scoring process 220 evaluates the populated model from step 610, and thus generates score 165. In a case where the populated model 520 includes a particular independent variable, e.g., number of signals (NS) 335, score 165 will be based on, i.e., will be a function of, that independent variable.

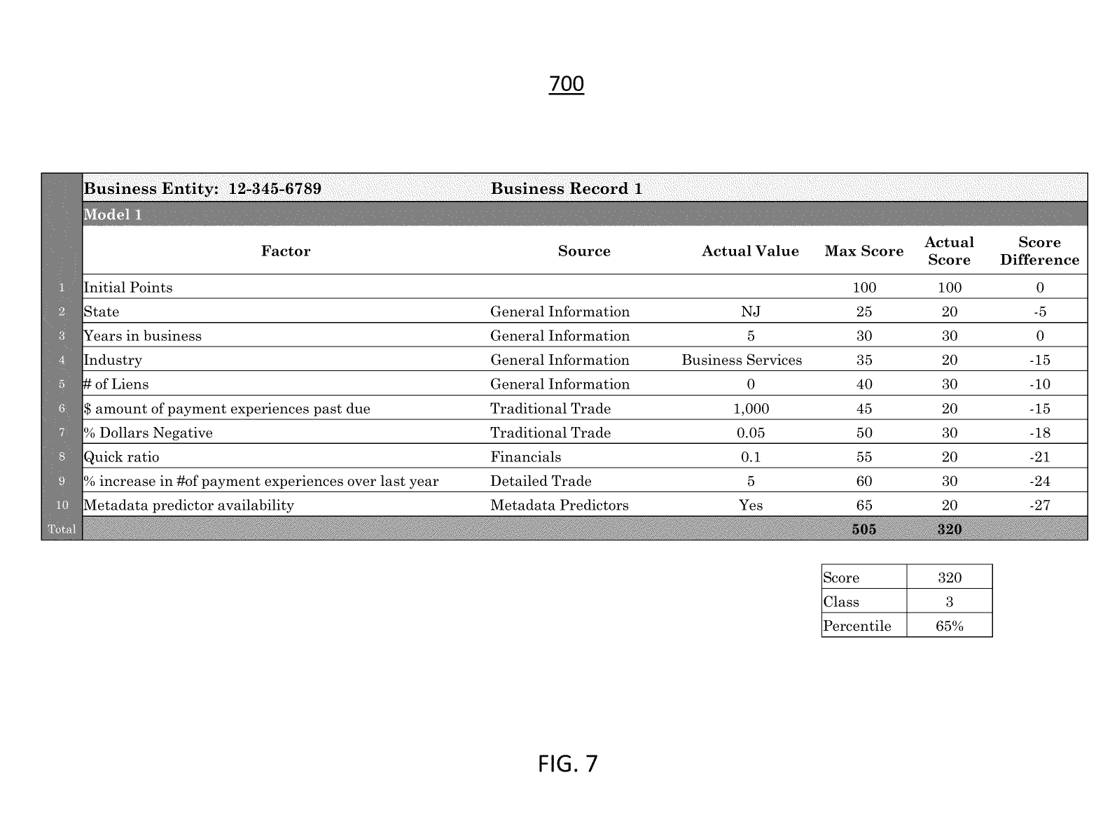

FIG. 7 is a table 700 that shows an example of a scorecard for a single business being scored in accordance with scoring process 220. An exemplary list of predictors, i.e., factors, illustrates how points from each predictor accumulate to a total score. A raw score is mapped to a percentile point and a class value that was defined based on population distribution. Percentile has the range of 1 to 100, where “100” means least risky. Percentile is created based on the score distribution of the universe. It creates a rank to a total population. Class, as an example defined on range 1-5 is based on the distribution of records on the total population. The least risky 10% of population is in class 1; the next 20% is assigned to the class 2. The middle 40% is in class 3. Following riskier 20% of population is classified in class 4. The most risky 10% of the population is assigned to class 5. Processor 115 prepares a report that includes table 700, and delivers the report to a user of computer 105 by way of user interface 110, or to a user of a remote device (not shown) by way of network 150.

In a trial operation, a total of 3,300,000 businesses were used to develop model 520. Trades reported on these businesses were classified into either one of two categories: “Good”, which is defined as less than 91 days past due, and “Bad”, which is defined as severely delinquent and in essence 91 or more days past due on their terms. Good accounts are paid on time or with minimal delays on their obligations. During model development, each business was weighted based on its percentage of “Good” trades and “Bad” trades. If, for example, for a particular business, 30% of the total amount owing is 91 or more days past due, and 70% is less than 91 past due, then this company is weighted 70% “Good” and 30% “Bad”. Of the 3,300,000 population, approximately 10.2% of the trade accounts associated with these businesses were “Bad”, or severely delinquent.

In the model development process, data is collected from minimum of two time periods designated as an observation window and a performance window. The observation window defines a period of time during which all identification and characteristic data are collected. The performance window defines the length of time the accounts are tracked to examine their payment behavior. A snapshot of data represents a time frame in which the model was developed and is representative of any other time frame. The predictive variables or the independent variables, which in combination can define the outcome and segmentation schemes that classify records in different groups of similar characteristics, are defined from this snapshot.

In an exemplary embodiment, the observation snapshot used was February 2011 and the performance snapshot was the twelve months from March 2011 to February 2012. From the observation window data, extensive data analysis was conducted to determine those variables that are statistically the most significant factors for predicting severe delinquency and calculated the appropriate weights for each.

System 100 creates predictors by using internal business operations data defined from metadata and granular levels of trade data. We found that data from our metadata 320 about operational procedures created are significant predictors in our models, especially for records with limited trade activity or no trade activity. We also used the detailed trade data to better distinguish good and bad payment behaviors. That source of data provided a set of significant predictors.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves.

The terms “comprises” or “comprising” are to be interpreted as specifying the presence of the stated features, integers, steps or components, but not precluding the presence of one or more other features, integers, steps or components or groups thereof. The terms “a” and “an” are indefinite articles, and as such, do not preclude embodiments having pluralities of articles.

What is claimed is:

1. A method comprising:
employing a computer to perform operations that include:
receiving, from a data source, by way of an electronic communication, a descriptor of a business;
matching said descriptor to data in a database, thus yielding a match, wherein said data includes a unique identifier of said business;
saving to a log, a signal that includes said unique identifier;
counting a quantity of signals that include said unique identifier in said log, thus yielding a number of said signals for said unique identifier; and
calculating a credit score for said business, based on said number of signals.

2. The method of claim 1,
wherein said operations also include:
including said number of signals as an independent variable in a data set; and
performing a regression analysis on said data set, thus yielding a model, and
wherein said calculating utilizes said model to calculate said credit score.

3. The method of claim 2,
wherein said matching also yields a code that indicates a level of confidence that said match is correct,
wherein said operations also include:
saving said code to said log; and
counting a quantity of signals that (a) include said unique identifier in said log and (b) indicate that said level of confidence is greater than or equal to a particular confidence level threshold, thus yielding a count of confident matches for said unique identifier, and
including said count of confident matches for said unique identifier as an independent variable in said data set.

4. The method of claim 2, further comprising:
obtaining from a database, with regard to each of a plurality of suppliers of said business, (a) a balance that is due to said supplier from said business, thus yielding a balance owed to said supplier, and (b) an amount of said balance owed that is past due, thus yielding a balance past due to said supplier;
calculating a total owed by said business to said plurality of suppliers, thus yielding a total balance owed;
calculating, for each said supplier, a ratio of (a) said balance past due to said supplier to (b) said balance owed to said supplier, thus yielding a corresponding delinquency ratio for said supplier;
designating that said business is a bad credit risk with regard to each of said suppliers having a corresponding delinquency ratio greater than a delinquency ratio threshold, thus yielding a set of suppliers for which accounts are designated as bad;
calculating a total amount owed to said set of suppliers for which accounts are designated as bad, thus yielding a bad total;
calculating a ratio of (a) said bad total to (b) said total balance owed, thus yielding a bad weight; and
including said bad weight as an independent variable in said data set.

5. The method of claim 1,
wherein said operations also include saving to said log, a corresponding time at which said matching yielded said match, and
wherein said counting includes only said signals that indicate that said corresponding time falls within a particular period of time.

6. A system comprising:
a processor; and
a memory that contains instructions that are readable by said processor to control said processor to:
receive, from a data source, by way of an electronic communication, a descriptor of a business;
match said descriptor to data in a database, thus yielding a match, wherein said data includes a unique identifier of said business;
save to a log, a signal that includes said unique identifier;
count a quantity of signals that include said unique identifier in said log, thus yielding a number of said signals for said unique identifier; and
calculate a credit score for said business, based on said number of signals.

7. The system of claim 6,
wherein said instructions also control said processor to:
include said number of signals as an independent variable in a data set; and
perform a regression analysis on said data set, thus yielding a model, and
wherein said instructions, to calculate said credit score, control said processor to utilize said model to calculate said credit score.

8. The system of claim 7,
wherein said instructions to perform said match, also control said processor to yield a code that indicates a level of confidence that said match is correct,
wherein said instructions also control said processor to:
save said code to said log; and
count a quantity of signals that (a) include said unique identifier in said log and (b) indicate that said level of confidence is greater than or equal to a particular confidence level threshold, thus yielding a count of confident matches for said unique identifier, and
include said count of confident matches for said unique identifier as an independent variable in said data set.

9. The system of claim 7, wherein said instructions also control said processor to:
obtain from a database, with regard to each of a plurality of suppliers of said business, (a) a balance that is due to said supplier from said business, thus yielding a balance owed to said supplier, and (b) an amount of said balance owed that is past due, thus yielding a balance past due to said supplier;
calculate a total owed by said business to said plurality of suppliers, thus yielding a total balance owed;
calculate, for each said supplier, a ratio of (a) said balance past due to said supplier to (b) said balance owed to said supplier, thus yielding a corresponding delinquency ratio for said supplier;
designate that said business is a bad credit risk with regard to each of said suppliers having a corresponding delinquency ratio greater than a delinquency ratio threshold, thus yielding a set of suppliers for which accounts are designated as bad;
calculate a total amount owed to said set of suppliers for which accounts are designated as bad, thus yielding a bad total;
calculate a ratio of (a) said bad total to (b) said total balance owed, thus yielding a bad weight; and
include said bad weight as an independent variable in said data set.

10. The system of claim 6,
wherein said instructions also control said processor to save to said log, a corresponding time at which said match to said descriptor yielded said match, and
wherein to count said quantity of signals, said processor includes only said signals that indicate that said corresponding time falls within a particular period of time.

11. A storage device comprising:
instructions that are readable by a processor to control said processor to:
receive, from a data source, by way of an electronic communication, a descriptor of a business;
match said descriptor to data in a database, thus yielding a match, wherein said data includes a unique identifier of said business;
save to a log, a signal that includes said unique identifier;
count a quantity of signals that include said unique identifier in said log, thus yielding a number of said signals for said unique identifier; and
calculate a credit score for said business, based on said number of signals.

12. The storage device of claim 11,
wherein said instructions also control said processor to:
include said number of signals as an independent variable in a data set; and
perform a regression analysis on said data set, thus yielding a model, and
wherein said instructions, to calculate said credit score, control said processor to utilize said model to calculate said credit score.

13. The storage device of claim 12,
wherein said instructions to perform said match, also control said processor to yield a code that indicates a level of confidence that said match is correct,
wherein said instructions also control said processor to:
save said code to said log; and
count a quantity of signals that (a) include said unique identifier in said log and (b) indicate that said level of confidence is greater than or equal to a particular confidence level threshold, thus yielding a count of confident matches for said unique identifier, and
include said count of confident matches for said unique identifier as an independent variable in said data set.

14. The storage device of claim 12, wherein said instructions also control said processor to:
obtain from a database, with regard to each of a plurality of suppliers of said business, (a) a balance that is due to said supplier from said business, thus yielding a balance owed to said supplier, and (b) an amount of said balance owed that is past due, thus yielding a balance past due to said supplier;
calculate a total owed by said business to said plurality of suppliers, thus yielding a total balance owed;
calculate, for each said supplier, a ratio of (a) said balance past due to said supplier to (b) said balance owed to said supplier, thus yielding a corresponding delinquency ratio for said supplier;
designate that said business is a bad credit risk with regard to each of said suppliers having a corresponding delinquency ratio greater than a delinquency ratio threshold, thus yielding a set of suppliers for which accounts are designated as bad;
calculate a total amount owed to said set of suppliers for which accounts are designated as bad, thus yielding a bad total;
calculate a ratio of (a) said bad total to (b) said total balance owed, thus yielding a bad weight; and
include said bad weight as an independent variable in said data set.

15. The storage device of claim 11,
wherein said instructions also control said processor to save to said log, a corresponding time at which said match to said descriptor yielded said match, and
wherein to count said quantity of signals, said processor includes only said signals that indicate that said corresponding time falls within a particular period of time.
